(19) United States
(12) Patent Application Publication
(10) Pub. No.: US 2011/0285677 A1
(43) Pub. Date: Nov. 24, 2011

(54) RFID-Based Display Devices Having Multiple Driver Chips

(75) Inventor: Ian J. FORSTER, Essex (GB)

(73) Assignee: AVERY DENNISON CORPORATION, Pasadena, CA (US)

(21) Appl. No.: 12/783,634

(22) Filed: May 20, 2010

(51) Int. Cl. G09G 5/00

(52) U.S. Cl. 345/205

(57) ABSTRACT

An RFID-based display device is provided with a plurality of display characters having a plurality of display elements, such as line segments or pixels. The display device further includes a plurality of driver chips for controlling the display elements and/or display characters. Each driver chip may control an individual display element or multiple display elements of a given display character. The driver chip and associated display character may be provided as a common structure, module or strap, with multiple straps being attached to a substrate to form a display device.

### FIELD OF THE DISCLOSURE

The present subject matter relates to radio frequency identification (“RFID”) devices. More particularly, the present subject matter relates to display devices incorporating RFID technology.

### DESCRIPTION OF THE RELATED ART

Display devices incorporating RFID technology are well known for presenting information regarding an item (e.g., the sales price of or features regarding the item) to customers in a store or other shopping area or to others as an information-dissemination aid. Display devices employing RFID technology are advantageous compared to traditional “static” displays in that they may be dynamic in nature, allowing for the displayed information to change without requiring manual intervention. This may be useful in updating the information of interest such as the price of an item or scrolling through various data points concerning the item.

Known RFID-based display devices typically incorporate a single-chip display driver. This driver, which may either incorporate the ability to communicate using RFID communication protocols or be driven via an interface from an RFID chip, has a number of output lines equal to or greater than the number of display elements to be driven. For example, when previously known displays contain multiple elements, such as forty elements, this requires the chip to have in excess of forty connections. Each connection requires a pad or port on the chip surface, which takes up area and complicates assembly, making a single-chip display driver relatively expensive.

### SUMMARY OF THE INVENTION

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, an RFID-based display device comprises a plurality of display elements collectively forming a display character and a plurality of driver chips. Each driver chip is associated with only one of the display elements.

In another aspect, an RFID-based display device comprises a plurality of driver chips and a plurality of display characters, with each display character comprising a plurality of display elements. Each driver chip is associated with only one of the display characters.

In a further aspect, an RFID-based display device is provided that attains the same functionality of previously known devices, but with a simpler and less expensive configuration than such previously known devices.

In yet another aspect, an RFID-based display device comprises a substrate and a strap mounted on the substrate. The strap comprises a display character comprising a plurality of display elements and a driver chip associated with the display character as part of a common structure.

### BRIEF DESCRIPTION OF THE DRAWINGS

FIG. 1 is a schematic diagram of an RFID-based display device wherein each element of a multi-element display character is controlled by an individual RFID chip;

FIG. 2 is a schematic diagram of an RFID-based display device wherein multiple elements of a multi-element display character are controlled by an individual RFID chip;

FIG. 3A is a front perspective view of an RFID-based display device wherein an RFID chip and associated display character are provided as parts of a common structure or strap;

FIG. 3B is a rear perspective view of the strap of FIG. 3A; and

FIG. 4 is a schematic diagram of a display device incorporating a plurality of the straps of FIGS. 3A and 3B.

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

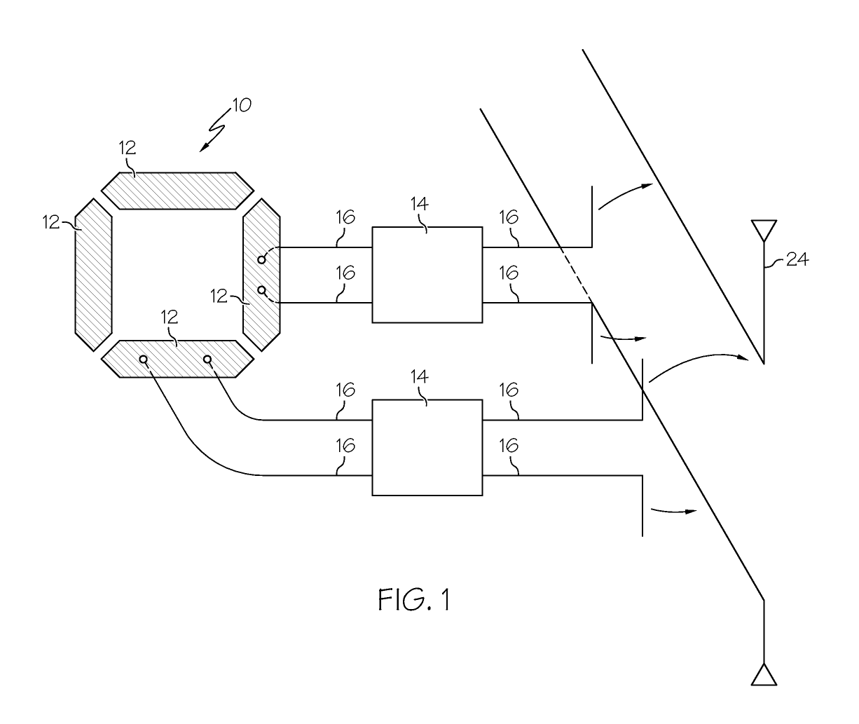

Display devices according to the present disclosure are comprised of a plurality of display characters 10, each of which is comprised of a plurality of individual elements or segments or pixels 12 (FIGS. 1-3A and 4). The elements 12 of the display characters 10 are addressed by an associated RFID driver chip 14.

In one embodiment, which is shown in FIG. 1, a single RFID chip 14 is associated with each display element 12 via one or more driver lines 16. To reduce the cost of the resulting display device, it may be advantageous for the RFID chips 14 to be relatively simple according to known design, with an RF communication port and a limited input/output capability, which serves to minimize the size and cost of the chips. While the chip 14 and display element 12 are shown with a physical interconnection (i.e., conductive driver lines 16), other means of communication therebetween (as will be described in greater detail herein) may also be employed without departing from the scope of the present disclosure.

The display character 10 illustrated in FIG. 1 is comprised of four elements 12, meaning that four chips 14 (two of which are shown) are employed to control the information presented by the display character 10. Each chip 14 has an individual identity, which allows the elements 12 to be individually addressed and operated independently of each other.

The identities of chips according to the various embodiments or aspects of this disclosure may be maintained in various storage devices. In one embodiment, the identity of the individual display elements 12 may be stored in the memory of one “master” RFID chip to allow a reader system to alter the elements 12. The “master chip” may include other information in its memory, such as a map of the display device to associate particular display elements with particular chip identities. A reader control system would read the master data and use it to control the display device via the other chips 14. In another embodiment, the identities of the chips 14 may be stored in a database and associated with one or more of the tag identities. In yet another embodiment, each chip 14 may store its own identity, which specifies what element it controls.

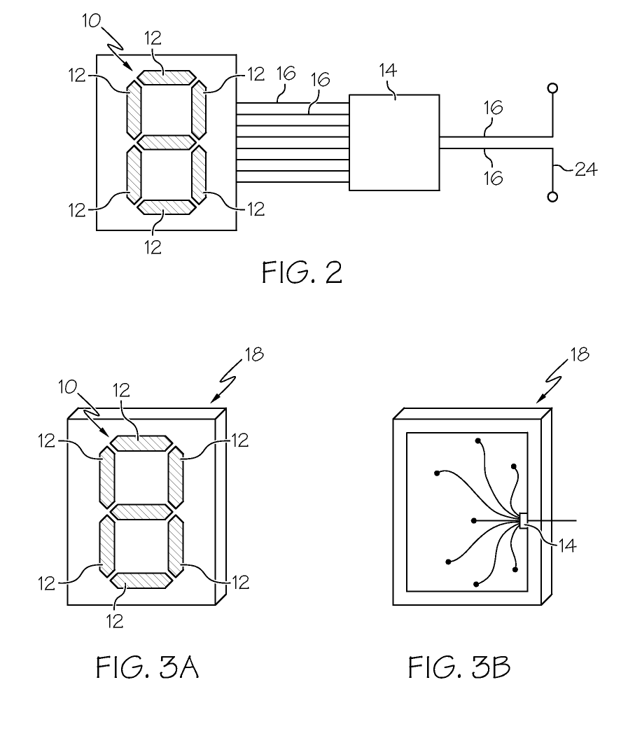

The embodiment of FIG. 2 differs from the embodiment of FIG. 1 in that a single chip 14 is associated with a plurality of display elements 12 of a single display character 10, rather than being associated with only one element 12. The chip 14 may drive all of elements 12 of the character 10 or fewer than all of the elements 12, with one or more other chips driving the other elements 12 of the character 10. While the chip 14 of FIG. 2 is associated with a plurality of display elements 12, the number of connections is advantageously limited to prevent the display from becoming overly complex and/or expensive. For example, it may be advantageous for the chip 14 to control the display elements 12 of no more than a single display character 10 (typically seven display elements 12, as shown in FIG. 2 for numbers and language letters) instead of a plurality of display characters.

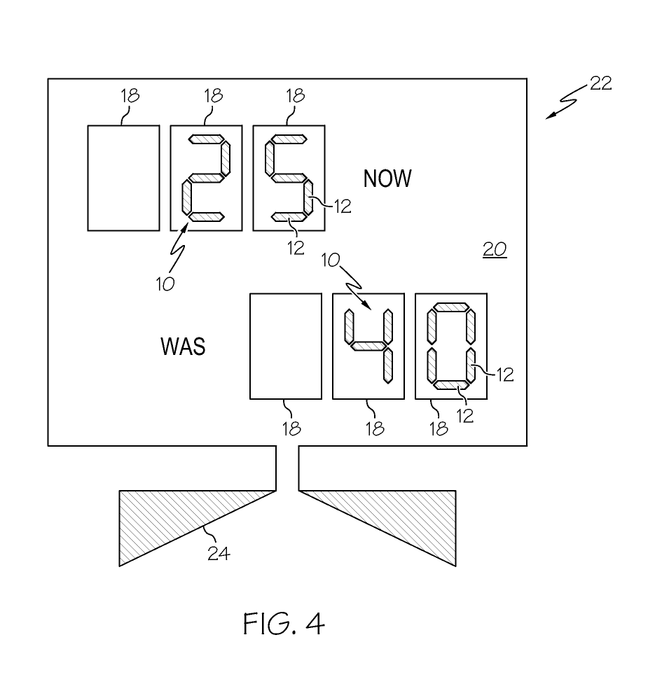

According to an alternative embodiment of the present disclosure, the RFID chip 14 and an associated display character 10 may be provided as parts of a common structure or module or strap 18, as shown in FIGS. 3A and 3B. The strap 18 can be mass produced at a relatively low cost and then assembled via suitable coupling means onto a substrate 20 containing a wide area communication and power interface to form a ticket or other display device 22 (FIG. 4). The nature of the substrate 20 may vary without departing from the scope of the present disclosure, but in one embodiment the substrate 20 is of the type typically used for flexible tags, such as polyester or paper.

The modules or straps 18 may be associated with the display device 22 using, for example, high speed strap attach technology. Display devices according to this embodiment may be advantageous in that production is optimized for a single device, but flexibility is retained in the complexity of the display device to be built using multiple display straps. For example, in the embodiment of FIG. 4, only the portions of the substrate 20 devoted to the individual characters 10 require display material (i.e., straps 18), rather than requiring display material (or film, in the case of electrophoretic displays) to be placed over the entire area of the substrate 20. The regions which do not require display material may be left blank or include fixed graphics, such as a bar code or other human-readable information about a product to which the display device 22 is attached.

The fundamental difference between the embodiments of FIGS. 1 and 2 and the embodiments of FIGS. 3A-4 can be understood as follows. In the embodiments of FIGS. 1 and 2, multiple chips 14 are mounted to a single structure (i.e., the display device). The benefits of such a system include efficiency of use of silicon area, relatively easy assembly, and reduced complexity of interconnect. In contrast, in the embodiments of FIGS. 3A-4, the modules or straps 18 are made as single functional units, which can either be used on their own or in combination with other straps 18 to form a larger display device 22. The benefits of such a system include the ability to mass produce the straps and use them in making any of a variety of possible display layouts.

In display devices according to the present disclosure, each chip 14 or each strap 18 may be provided with its own power and/or communication structure or antenna 24 (FIG. 2) to allow it to be controlled by an RFID reader. Alternatively, as shown in FIGS. 1 and 4, two or more chips 14 or straps 18 may share a common antenna 24. The antenna 24 of FIG. 4 is shown as a loop around the periphery of the display device 22, which drives the straps 18 of the display device 22. If the display is relatively small, providing a common antenna 24 may be the only practical approach, whereas individualized antennae may be employed with larger displays, which may be advantageous for certain applications. To minimize the complexity (and, hence, cost) of the system, the chips 14 or straps 18 may be placed locally to the associated display element(s), coupled to the antenna 24.

The chips 14 may be coupled to the associated antenna 24 by either conductive arrangements or reactive arrangements. Conductive coupling requires driver lines or tracks 16 to be routed between the antenna 24 and the associated chip 14, as in FIGS. 1 and 2. In contrast, reactive coupling employs an electric field (coupling via capacitance) or a magnetic field (inductive coupling) or a combination thereof to give a high degree of flexibility in the arrangement of the various display elements and characters. Reactive coupling tends to work particularly well in embodiments wherein the display character is manufactured as a discrete module to be later arranged to form a display, as in FIG. 4. The reason for this is that it may be easier to connect the modules to a common surface or substrate containing an antenna with a non-conductive adhesive (such as a pressure-sensitive adhesive) than by a conductive adhesive or by some other method, such as soldering or welding. It will be seen that the display device 22 of FIG. 4 employs a reactive coupling system, with current flowing through the loop antenna 24 creating a magnetic field available to the modules or straps 18 connected to the substrate 20.

In one embodiment, the antenna 24 provides communication and (optionally) power in the form of an RF signal. Alternatively, power may be provided to the chips 14 by a battery, either as a DC connection or via a coincident AC signal generated from the battery that is rectified by the RFID chip 14 to provide a power source. Other methods of delivering power to the chips may also be employed without departing from the scope of the present disclosure. All of the chips 14 coupled to the same antenna 24 will typically apply voltages and/or waveforms (depending on the nature of the antenna 24), that are the same as or similar to the voltages and/or waveforms supplied by a more complex driver chip.

The means by which the chips 14 control the associated element or elements may vary. For example, in one embodiment, the associated element or elements may be energized simply upon any communication from the chip 14 to the element or elements. Alternatively, control of the associated element or elements may be more advanced, such as by sending a particular command from the antenna 24 to the chip 14. In one example (which assumes that the chip 14 has two outputs capable of being set to a defined voltage or nominal ground), the command causes either a positive differential voltage, a negative differential voltage, or no differential to change the display state. The waveform and timing for controlling the element or elements can either be either digitally created inside the chip 14 or simply passed through from the antenna 24 (e.g., the chip 14 receives data in the form of AM modulation of the incoming beam and the waveform detected can be passed through to control the display).

As for the display elements 12, their nature and configuration may vary without departing from the scope of the present disclosure. For example, the display elements 12 may be bi-stable or mono-stable. Bi-stable display elements retain their state when power is removed, whereas mono-stable or active display elements require some level of refreshing and power input, thereby consuming more power than bi-stable displays. A bi-stable display element may incorporate, for example, electrophoretic technology, certain types of liquid crystals, or certain electrochromic structures. A mono-stable display element may incorporate, for example, certain types of liquid crystals or organic or conventional light-emitting diodes.

The versatility of display devices according to the present disclosure will be appreciated. The number of connections, and hence the number of input/output ports, may be optimized to achieve the best possible cost for a complete display device, taking into account the chip cost (which is dependent at least in part upon chip area), the number of chips used, and the ease of assembly and reduction in complexity of the interconnections required. Additionally, the basic structure of the various chips (e.g., the number of input/output ports) may vary, so individual chips may be customized to be optimal for the associated display element or elements.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof including as combinations of features that are individually disclosed or claimed herein.

What is claimed is:

1. An RFID-based display device, comprising:
a plurality of display elements collectively forming a display character; and
a plurality of driver chips, wherein each driver chip is associated with only one of the display elements.

2. The RFID-based display device of claim 1, further comprising a plurality of antennae for providing power and/or communication to the driver chips, wherein each antenna is associated with only one of the driver chips.

3. The RFID-based display device of claim 1, further comprising an antenna for providing power and/or communication to the driver chips, wherein the antenna is associated with more than one of the driver chips.

4. The RFID-based display device of claim 1, further comprising an antenna for providing power and/or communication to at least one of the driver chips, wherein the antenna is conductively coupled to said at least one of the driver chips.

5. The RFID-based display device of claim 1, further comprising an antenna for providing power and/or communication to at least one of the driver chips, wherein the antenna is reactively coupled to said at least one of the driver chips.

6. An RFID-based display device, comprising:
a plurality of display characters each comprising a plurality of display elements and
a plurality of driver chips, wherein each driver chip is associated with only one of said display characters.

7. The RFID-based display device of claim 6, wherein one of said driver chips is associated with all of the display elements of a single display character.

8. The RFID-based display device of claim 6, wherein one of said driver chips is associated with fewer than all of the display elements of a single display character.

9. The RFID-based display device of claim 6, further comprising a plurality of antennae for providing power and/or communication to the driver chips, wherein each antenna is associated with only one of the driver chips.

10. The RFID-based display device of claim 6, further comprising an antenna for providing power and/or communication to the driver chips, wherein the antenna is associated with more than one of the driver chips.

11. The RFID-based display device of claim 6, further comprising an antenna for providing power and/or communication to at least one of the driver chips, wherein the antenna is conductively coupled to said at least one of the driver chips.

12. The RFID-based display device of claim 6, further comprising an antenna for providing power and/or communication to at least one of the driver chips, wherein the antenna is reactively coupled to said at least one of the driver chips.

13. An RFID-based display device, comprising:
a substrate; and
a strap mounted on the substrate, wherein the strap comprises:
a display character comprising a plurality of display elements; and
a driver chip associated with the display character as part of a common structure.

14. The RFID-based display device of claim 13, further comprising a plurality of straps and a plurality of antennae for providing power and/or communication to the straps, wherein each antenna is associated with only one of the straps.

15. The RFID-based display device of claim 13, further comprising a plurality of straps and an antenna for providing power and/or communication to the straps, wherein the antenna is associated with more than one of the straps.

16. The RFID-based display device of claim 13, further comprising an antenna for providing power and/or communication to the strap, wherein the antenna is conductively coupled to the strap.

17. The RFID-based display device of claim 13, further comprising an antenna for providing power and/or communication to the strap, wherein the antenna is reactively coupled to the strap.
